(19) United States
(12) Patent Application Publication
(10) Pub. No.: US 2015/0193439 A1
(43) Pub. Date: Jul. 9, 2015

(54) SCHEMALESS DATA ACCESS MANAGEMENT

(71) Applicant: International Business Machines Corporation, Armonk, NY (US)

(72) Inventors: Nitin Gaur, Round Rock, TX (US); Christopher D. Johnson, Rochester, MN (US); Brian K. Martin, Cary, NC (US)

(73) Assignee: International Business Machines Corporation, Armonk, NY (US)

(21) Appl. No.: 14/150,410

(22) Filed: Jan. 8, 2014

(51) Int. Cl. G06F 17/30

(52) U.S. Cl. CPC G06F 17/3033

(57) ABSTRACT

Techniques are described for managing data between an in-memory data grid and a schemaless data store. In one example, a method includes generating hash codes for one or more keys. Each key is associated with one data item from a plurality of data items in the schemaless data store. The method further includes storing the hash codes in a persistent data structure. The method further includes receiving a request via the in-memory data grid to access a selected data item, wherein the selected data item has an associated key. The method further includes deriving a hash code for the key associated with the selected data item. The method further includes determining whether the derived hash code is present in the persistent data structure. The method further includes performing an operation based on the determination of whether the derived hash code is present in the persistent data structure.

### TECHNICAL FIELD

The present disclosure relates to data storage, and in particular, to data access between memory and data storage.

### BACKGROUND

A software-based elastic caching platform may be used for caching large amounts of data in data-intensive enterprise computing infrastructure. For example, a software-based system may implement an elastic caching platform by interconnecting and virtualizing the memory resources of a number of computing resources (such as Java virtual machines (“JVMs”)) to act together as an in-memory data grid. A software-based in-memory data grid may act as an integrated address space for in-memory data access for one or more applications. An in-memory data grid may dynamically process, partition, replicate, and manage application data and business logic across large numbers of servers, such as hundreds, thousands, or more servers. The in-memory data grid may also partition and shard its data to promote scalability. In an elastic caching system, servers may be added to or removed from an in-memory data grid, and the software-based system may automatically redistribute the in-memory data grid to make the best use of available resources, while still providing continuous access to the data with fault tolerance.

A software-based, elastic caching in-memory data grid may be operated across multiple data centers, and may be integrated with other application infrastructure systems. Those additional systems may include schemaless or non-relational data store technology, sometimes colloquially referred to as “NoSQL” data stores. These schemaless data stores may be based on key-value stores, document stores, or other schemaless or non-relational data stores that have various features outside the scope of traditional relational database management systems (RDMBS).

An in-memory data grid may be key addressable by one or more enterprise applications. A given application can store a value in the data grid at a key. An in-memory data grid may replicate its data to provide fault tolerance and prevent loss of data. An in-memory data grid may also write data to any of one or more data stores, which may include schemaless data stores, relational databases, multidimensional data cubes, or other data stores.

### SUMMARY

In general, examples disclosed herein are directed to techniques for managing data between an in-memory data grid and one or more schemaless data stores, such as a cache synchronization manager that may use a probabilistic data filter structure to selectively synchronize the data in an in-memory data grid from a schemaless data store.

In one example, a method for managing data between an in-memory data grid and a schemaless data store includes generating one or more hash codes for each of one or more keys, wherein each key of the one or more keys is associated with one data item from a plurality of data items stored in the schemaless data store. The method further includes storing the one or more hash codes in a persistent data structure. The method further includes receiving a request via the in-memory data grid to access a selected data item from the plurality of data items, wherein the selected data item has an associated key. The method further includes determining a derived hash code for the key associated with the selected data item. The method further includes determining whether the derived hash code is present in the persistent data structure. The method further includes performing an operation based on the determination of whether the derived hash code is present in the persistent data structure.

In another example, a computer program product for managing data between an in-memory data grid and a schemaless data store includes a computer-readable storage medium having program code embodied therewith. The program code is executable by a computing device to generate one or more hash codes for each of one or more keys, wherein each key of the one or more keys is associated with one data item from a plurality of data items stored in the schemaless data store. The program code is further executable by a computing device to store the one or more hash codes in a persistent data structure. The program code is further executable by a computing device to receive a request via the in-memory data grid to access a selected data item from the plurality of data items, wherein the selected data item has an associated key. The program code is executable by a computing device to determine a derived hash code for the key associated with the selected data item. The program code is further executable by a computing device to determine whether the derived hash code is present in the persistent data structure. The program code is further executable by a computing device to perform an operation based on the determination of whether the derived hash code is present in the persistent data structure.

In another example, a computer system for managing data between an in-memory data grid and a schemaless data store includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to generate one or more hash codes for each of one or more keys, wherein each key of the one or more keys is associated with one data item from a plurality of data items stored in the schemaless data store. The computer system further includes program instructions, stored on at least one of the one or more storage devices for execution by at least one of the one or more processors via at least one of the one or more memories, to store the one or more hash codes in a persistent data structure. The computer system further includes program instructions, stored on at least one of the one or more storage devices for execution by at least one of the one or more processors via at least one of the one or more memories, to receive a request via the in-memory data grid to access a selected data item from the plurality of data items, wherein the selected data item has an associated key. The computer system further includes program instructions, stored on at least one of the one or more storage devices for execution by at least one of the one or more processors via at least one of the one or more memories, to determine a derived hash code for the key associated with the selected data item. The computer system further includes program instructions, stored on at least one of the one or more storage devices for execution by at least one of the one or more processors via at least one of the one or more memories, to determine whether the derived hash code is present in the persistent data structure. The computer system further includes program instructions, stored on at least one of the one or more storage devices for execution by at least one of the one or more processors via at least one of the one or more memories, to perform an operation based on the determination of whether the derived hash code is present in the persistent data structure.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an enterprise computing system that includes a cache synchronization manager (or “cache sync manager”) that may be used with an in-memory data grid and one or more schemaless data stores, in accordance with an example of this disclosure.

FIG. 2 is a block diagram illustrating an enterprise computing system that includes a cache sync manager that may be used with an in-memory data grid and one or more schemaless data stores, in accordance with another example of this disclosure.

FIG. 3 depicts a block flow diagram of example data access operation flow for various examples of operations among enterprise applications, an in-memory data grid, a cache sync manager, and schemaless data stores, in accordance with an example of this disclosure.

FIG. 4 shows a flowchart for an example overall process that a cache sync manager may perform, in accordance with an example of this disclosure.

FIG. 5 is a block diagram of a computing device that may be used to execute a cache sync manager, in accordance with an example of this disclosure.

### DETAILED DESCRIPTION

Various examples are disclosed herein for filtering data access and synchronizing data that may be used with an in-memory data grid (IMDG) and one or more schemaless data stores. In some examples, a system of this disclosure may be implemented as a cache synchronization manager that may provide filtering, synchronization, and cache persistence for data access via an in-memory data grid using schemaless data sources.

An in-memory data grid may access data from any available data stores, if an application requests data that the in-memory data grid does not already have loaded. When an application requests data from an in-memory data grid and the in-memory data grid contains the data, the in-memory data grid may locate and return the data to the application substantially more quickly than if the data had to be retrieved from one of the data sources. An in-memory data grid may potentially store very large amounts of data, such as terabytes of data in some examples. The in-memory data grid may provide fast access to that data for the applications under intensive use cases. For example, an in-memory data grid may provide concurrent data access in thousands or more transactions per second, and to thousands or more concurrent application instances.

Using an in-memory data grid to store high-demand data may therefore substantially increase speed of data access, particularly in high-load applications accessing a variety of data from a large enterprise data collection. When an application calls for data that is not stored in the in-memory data grid, the system then often needs to retrieve the data from some form of long-term data storage, such as retrieving the data from some form of persistent, long-term data storage, typically based on hard disc drive storage in a data center. This typically requires additional time for data retrieval that may result in slower overall performance for the application requesting the data.

In some examples, a cache synchronization manager (or “cache sync manager”) of this disclosure may mediate between an in-memory data grid and a schemaless data store. A cache sync manager may perform functions including one or more of the following: ensuring that an in-memory data grid caches only a selective subset of the available data in a schemaless data store; performing bi-directional synchronization between an in-memory data grid and a schemaless data store; performing probabilistic filtering of data access between an in-memory data grid and a schemaless data store; and providing cache persistence to otherwise volatile cache memory of the in-memory data grid. Examples of this disclosure may thereby provide performance advantages in the operation of an in-memory data grid configured to access one or more schemaless data stores.

A cache sync manager of this disclosure may use a probabilistic data structure to perform probabilistic tracking of data that is synchronized between an in-memory data grid and a schemaless data store, and provide probabilistic prevention of potentially unnecessary data storage access operations to the schemaless data store. A cache sync manager of this disclosure may also track (such as through key-value pairs) what portions of data from a schemaless data store should be available in cache in the in-memory data grid, and re-populate data in the in-memory data grid from the schemaless data store as needed if the data is missing from the grid. A cache sync manager of this disclosure may thereby provide cache persistence to an otherwise volatile cache memory of an in-memory data grid.

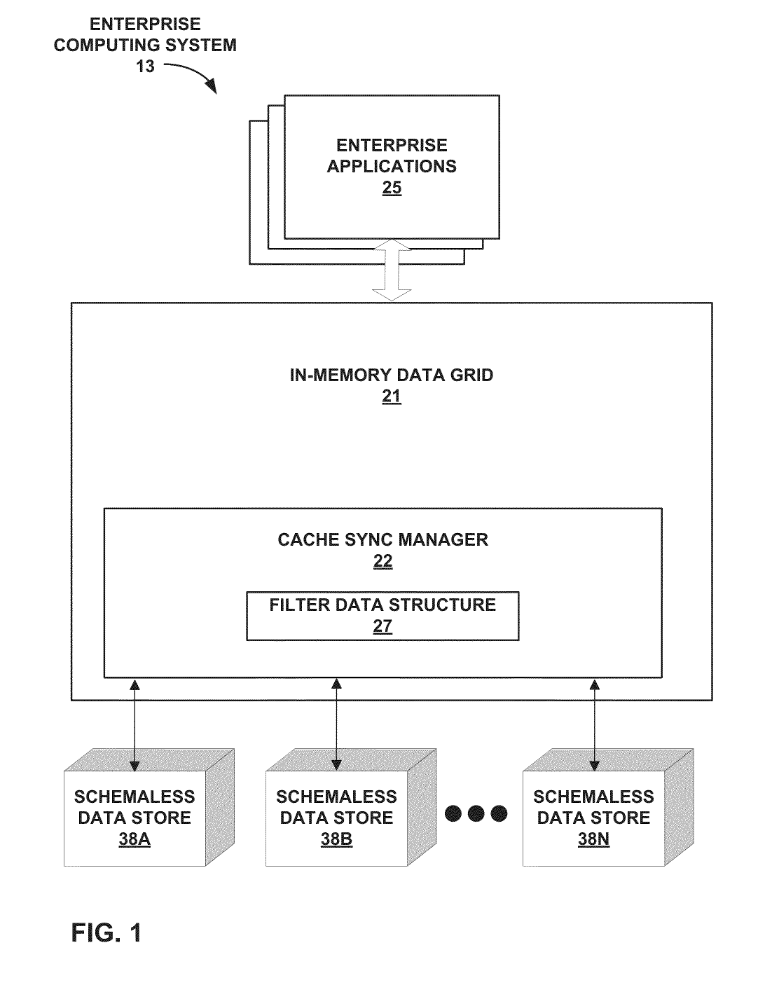

FIG. 1 is a block diagram illustrating an example enterprise computing system 13 that includes a cache synchronization manager (or “cache sync manager”) 22 that may be used with an in-memory data grid 21 and one or more schemaless data stores 38A, 38B, . . . , 38N (“data stores 38”), in accordance with one example of this disclosure. In-memory data grid 21 may store large amounts of data (e.g., terabytes or petabytes of data) in a fast-access working memory configuration for high availability to enterprise application 25. In-memory data grid 21 may store this data in a volatile, non-persistent cache form, such as in the random access memory (RAM) of a large number of virtual machines. In FIG. 1, enterprise computing system 13 also includes one or more enterprise applications 25 that may access, process, add to, or otherwise interact with in-memory data grid 21. In-memory data grid 21 may configure the combined cache memory of a large number of virtual machines as a single address space addressable by enterprise applications 25. Enterprise computing system 13 and its components may be implemented in a single facility or widely dispersed in two or more separate locations anywhere in the world, in different examples.

Cache sync manager 22 may manage or enable synchronization, filtering, and persistence for cache memory functions of in-memory data grid 21, including in its interactions with one or more schemaless data stores 38. Cache sync manager 22 may be implemented as a software application, module, library, or other set or collection of software, and may work cooperatively with, be part of, or be added to software that implements or manages in-memory data grid 21, in some examples. Cache sync manager 22 may act as a generic, pluggable, persistent data store tier that provides persistence for the non-persistent cache of in-memory data grid 21, among other advantages. Cache sync manager 22 may include synchronization logic to perform bi-directional synchronization of data between in-memory data grid 21 and schemaless data stores 38. Cache sync manager 22 may provide probabilistic access filtering between in-memory data grid 21 and schemaless data stores 38.

Cache sync manager 22 may use a filter data structure 27 to selectively load data from schemaless data stores 38 into in-memory data grid 21. Cache sync manager 22 may perform a hashing function to take a hash of the keys from data items (e.g., key-value pairs) in schemaless data stores 38 (e.g., a key-value store), and store the resulting hash codes in filter data structure 27. Filter data structure 27 may be implemented to be or to include a hash table, in some examples. In some examples, cache sync manager 22 may pass the resulting hash codes to in-memory data grid 21 or store the resulting hash codes in schemaless data store 38, as well as storing the resulting hash codes in filter data structure 27. In some examples, cache sync manager 22 may perform any of various kinds of algorithms or coding techniques to generate codes indicative of the data items or the keys associated with the data items. Any type of code indicative of data items or keys associated with the data items may be referred to as hash codes or may be considered in common with hash codes, for purposes of this disclosure. Filter data structure 27 may be implemented as a probabilistic data structure, such as the efficient probabilistic filtering data structure known as a Bloom filter, in some examples.

Schemaless data stores 38 may include any type of schemaless or non-relational database type of data store, including those referred to colloquially as “NoSQL” data stores. For example, schemaless data stores 38 may include key-value stores, document stores, column stores, graph data stores, and other data stores with non-relational structure. Schemaless data stores may offer advantages over traditional relational databases in how the data from schemaless data stores is amenable to hosting in cache memory in an in-memory data grid 21. Cache sync manager 22 may contribute to those advantages by synchronizing, filtering, and providing cache persistence to the data between in-memory data grid 21 and schemaless data stores 38. Cache sync manager 22 may thereby be thought of, in some examples, as helping to blur the distinction between memory and data storage between in-memory data grid 21 and schemaless data stores 38, promoting fast response times to data requests to in-memory data grid 21.

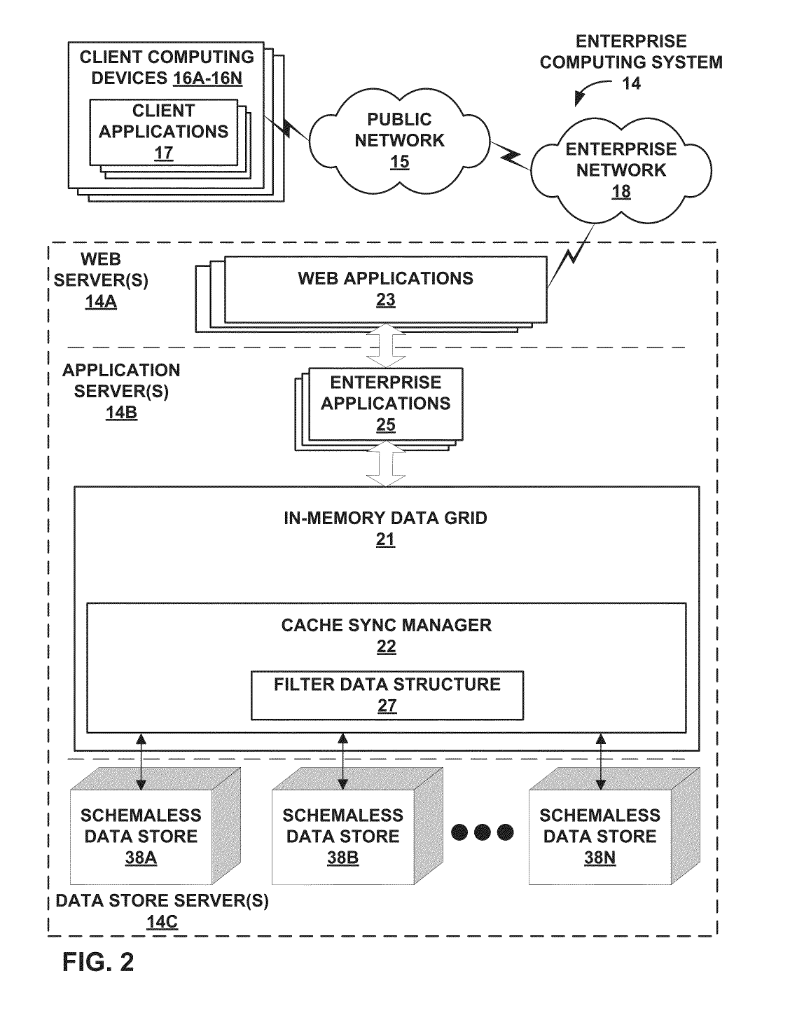

For exemplary purposes, various examples of the techniques of this disclosure may be readily applied to various software systems, including large-scale enterprise computing and software systems, and including computing systems with intensive demands for large amounts of data with high availability for processing. Examples of enterprise software systems include enterprise financial or budget planning systems, order management systems, inventory management systems, sales force management systems, business intelligence tools, enterprise reporting tools, project and resource management systems, and other enterprise software systems. The operation of cache sync manager 22 in the context for such an enterprise computing environment is described below with reference to FIG. 2.

In the example of FIG. 1, cache sync manager 22 may therefore perform a method for managing data between in-memory data grid 21 and schemaless data store 38. Cache sync manager 22 may generate one or more hash codes for each of one or more keys, wherein each key of the one or more keys is associated with one data item from a plurality of data items stored in schemaless data stores 38. Cache sync manager 22 may store the one or more hash codes in a persistent data structure, such as filter data structure 27. Cache sync manager 22 may receive a request via in-memory data grid 21 to access a selected data item from the plurality of data items, wherein the selected data item has an associated key or is associated with a key. Cache sync manager 22 may determine a derived hash code for the key associated with the selected data item, and determine whether the derived hash code is present in the persistent data structure, such as filter data structure 27.

Cache sync manager 22 may then perform an operation based on its determination of whether the derived hash code is present in the persistent data structure. Performing the operation based on the determination of whether the derived hash code is present in the persistent data structure may include providing a response via in-memory data grid 21 that the selected data item is not available in schemaless data stores 38 (e.g., if cache sync manager 22 determines that the hash code for the requested data item is not present in filter data structure 27), or requesting the selected data item from schemaless data store 38 or one of schemaless data stores 38 (e.g., if cache sync manager 22 determines that the hash code for the requested data item is present in filter data structure 27). If cache sync manager 22 requested the selected data item from schemaless data store 38, cache sync manager 22 may receive the selected data item from the schemaless data store and provide the selected data item via in-memory data grid 21 to the requesting enterprise application 25, and/or may load the selected data item to in-memory data grid 21, in some examples. Load the selected data item to in-memory data grid 21 may include cache sync manager 22 loading data from a schemaless data format from schemaless data store 38 into an object in in-memory data grid 21.

Cache sync manager 22 may also receive information from schemaless data stores 38 indicating that the selected data item is not available in schemaless data stores 38. Cache sync manager 22 may provide a response to the requesting enterprise application 15 via in-memory data grid 21 that the selected data item is not available in schemaless data stores 38.

Cache sync manager 22 may take the form of application code that is executed by one or more processors of one or more computing devices, such that the same processor may perform some or all of the operations performed by cache sync manager 22, or different processors, potentially as part of various computing devices, may execute any one or more operations performed by or attributed to cache sync manager 22. Thus, any of the actions described above may be executed by at least one processor, such that any action may be performed by at least one processor that does not necessarily refer to or have antecedent basis with any other processor that executes any other action performed by or attributed to cache sync manager 22.

FIG. 2 is a block diagram illustrating enterprise computing system 14 that includes a cache sync manager 22 that may be used with an in-memory data grid 21 and one or more schemaless data stores 38, in accordance with another example of this disclosure. Enterprise computing system 14, as depicted in the non-limiting example of FIG. 2, includes some additional detail beyond that shown in the example of enterprise computing system 13 of FIG. 1. In the system shown in FIG. 2, enterprise computing system 14 is communicatively coupled to a number of client computing devices 16A-16N (collectively, “client computing devices 16” or “computing devices 16”) by an enterprise network 18 and a public network 15. Users may use client applications 17 executing on their respective computing devices 16 to access enterprise computing system 14 and enterprise applications 25. In some examples, client computing devices may connect to web applications 23 directly through enterprise network 18. In some examples, client computing devices may connect directly to enterprise applications 25.

In the example of FIG. 2, enterprise computing system 14 includes servers that run data-intensive enterprise applications 25, which may process large amounts of data from schemaless data stores 38. A user may use a client computing device 16 to access and manipulate information processed and provided by those data-intensive applications. Users may use a variety of different types of computing devices 16 to interact with enterprise computing system 14 and access features and resources of enterprise applications 25 that make use of in-memory data grid 21 and schemaless data stores 38. For example, a selected one of computing devices 16 may take the form of a laptop computer, a desktop computer, a smartphone, a tablet computer, or other device. Client application 17 executing on a particular client computing device 16 may be implemented as an installed client application, a dedicated mobile application, a web browser running a user interface for a web application, or other means for interacting with enterprise computing system 14.

Enterprise network 18 and public network 15 may represent any communication network, and may include a packet-based digital network such as a private enterprise intranet or a public network like the Internet. In this manner, enterprise computing system 14 can readily scale to suit large enterprises. Any one of enterprise applications 25 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise computing system 14 is implemented in accordance with a three-tier architecture: (1) one or more web servers 14A that provide web applications 23 with user interface functions; (2) one or more application servers 14B that provide an operating environment for enterprise software applications 25 and a data access service, which may take the form of or include in-memory data grid 21; and (3) one or more data store servers 14C that provide one or more schemaless data stores 38A, 38B, . . . , 38N (“schemaless data stores 38”). In the example of FIG. 2, cache sync manager 22 may form part of in-memory data grid 21. In various examples, cache sync manager 22 may be integrated with in-memory data grid 21 as a part of in-memory data grid 21, or may be separate from in-memory data grid 21 and configured to work in cooperation with in-memory data grid 21. In some example implementations, data store servers 14C may also host relational databases (not depicted in FIG. 2) configured to receive and execute SQL queries, and/or multidimensional databases or data cubes (not depicted in FIG. 2).

Schemaless data stores 38 may be implemented using a variety of vendor platforms, and may be distributed in any configuration throughout the enterprise, from being hosted on a single computing device or virtual machine, to being distributed among thousands or more servers among multiple data centers in different locations around the world. Similarly, application servers 14B that implement, execute, or embody cache sync manager 22, potentially as well as in-memory data grid 21 and/or enterprise applications 25, may include any one or more real or virtual servers that may be hosted in one or more data centers or computing devices of any type, that may potentially be physically located at any one or more geographically dispersed locations.

Example embodiments of the present disclosure, such as cache sync manager 22 depicted in FIGS. 1 and 2, may enable filtering, synchronization, cache persistence, and other functions to manage data access and storage among schemaless data stores 38, in-memory data grid 21, and enterprise applications 15. As described above and further below, cache sync manager 22 may be implemented in one or more computing devices, and may involve one or more applications or other software modules that may be executed on one or more processors. Example embodiments of the present disclosure may illustratively be described in terms of the example of cache sync manager 22 in various examples described below.

Various examples of schemaless data stores 38 may be implemented as a key-value store, a document store, a column store, or a graph data store, for example. In some examples, a cache sync manager 22 of this disclosure may bridge data types in schemaless data stores 38 (e.g., key-value pairs in a key-value store, documents in a document store, columns in a column store, graph elements in a graph data store) and data types required for in-memory data grid 21 (e.g., objects). For example, in-memory data grid 21 may treat all data as objects (e.g., Java objects), and cache sync manager 22 may load data from a type of data in one of schemaless data stores 38 to objects that are correctly formatted or configured for in-memory data grid 21.

For example, in response to an enterprise application 25 requesting a data item that is not present in in-memory data grid, cache sync manager 22 may create an object with an object map, and load the key-value pairs for a requested data item from a key-value store among schemaless data stores 38 into the object map of the object in in-memory data grid 21. In-memory data grid 21 may then manage the object among the interconnected virtual machines that are virtualized into the single cache memory address space of in-memory data grid 21 addressable by enterprise applications 25. Another data item requested by enterprise application 25 may be located in a different schemaless data store 38 implemented as a document store, and cache sync manager 22 may create a new object with an object map, and load the data for the requested data item from a document from the appropriate document store among schemaless data stores 38 into the object map of the new object in in-memory data grid 21. By loading the data from any of various schemaless data types to the appropriate data type for in-memory data grid 21, cache sync manager 22 may ensure proper and fast loading and synchronization between schemaless data stores 38 and in-memory data grid 21. This may include when an enterprise application 25 updates or requests data from transactional cache, which may typically be handled by in-memory data grid 21.

To support its filtering function, cache sync manager 22 may perform a hashing algorithm on keys for data items from schemaless data stores 38. Cache sync manager 22 may then store the resulting hash code from the hash of keys from schemaless data stores 38. In some examples, cache sync manager 22 may store the hash code in a filter data structure 27. In-memory data grid 21 and cache sync manager 22 may subsequently receive a request from enterprise applications 25 for data, such as for one or more key-value pairs. If in-memory data grid 21 does not already contain the requested data, cache sync manager 22 may use filter data structure 27 as a probabilistic filter to match the data request with data available in schemaless data stores 38.

Cache sync manager 22 may test whether the requested one or more key-value pairs are part of a data item (e.g., a document set in a document store) stored in the schemaless data stores 38. If cache sync manager 22 finds the requested data in schemaless data stores 38, cache sync manager 22 may then load the data from the data type of the schemaless data store to the appropriate data type (e.g., an object) for the in-memory data grid 21. This may include cache sync manager 22 loading data from key-value pairs in a key-value data store, documents in a document store, columns in a column store, graph elements (e.g., nodes, edges, and properties) in a graph data store, to objects or other appropriate data types for in-memory data grid 21.

Cache sync manager 22 may thereby prepare itself for rapid access of the data in an example key-value schemaless data store among schemaless data stores 38 by performing a hashing algorithm on all (or some of) the keys in the key-value schemaless data store, and storing the resulting hash code in filter data structure 27. When cache sync manager 22 receives a request for data in the form of one or more key-value pairs that is not already loaded in in-memory data grid 21, cache sync manager 22 may run the request through filter data structure 27 to perform data matching, and then selectively load the data from the schemaless data store 38 into in-memory data grid 21. Cache sync manager 22 may therefore, in certain examples, act as a back end synchronization engine, using filter data structure 27 as a probabilistic data structure, that may perform data matching and subsequent loading for data in schemaless data stores 38 in response to data requests from enterprise applications 25, and place data from schemaless data stores 38 into in-memory data grid 21.

In one illustrative example, in-memory data grid 21 may manage data in the form of objects (e.g., Java objects). An object in in-memory data grid 21 may include an object map, and each object map may include a collection of key/value pairs, in which each key maps to a unique value. Each key and each value may take the form of an integer, a variable, a string, or an object of any kind, in some examples. Any type of data may be stored in one or more values in an object.

In this example, schemaless data stores 38 may include a plurality of document model data stores, potentially among other types of schemaless data stores. A representative example schemaless data store 38A may include a document model data store that includes a collection “things.” One example document stored in collection “things” in schemaless data store 38A may include the following example data:

{“_id”: “13434”,

“value1:” “sfsd”

“value2:” “sfsd”

“Items”: [{“_id”: “3fef2”,

“t2value”: “abcd”, . . . }]}

Cache sync manager 22 may retrieve this document and add its data to the object map of an object in in-memory data grid 21. Cache sync manager 22 may use a probabilistic data structure to selectively get data from schemaless data stores 38 into in-memory data grid 21. Cache sync manager 22 may also take a hash of one or more keys associated with the document, and store the one or more hash codes to filter data structure 27. Cache sync manager 22 may be enabled to check filter data structure 27 to determine keys that are not present in schemaless data stores 38, potentially more quickly than by accessing schemaless data stores 38, and thereby avoid potentially costly data access requests to schemaless data stores 38 in cases where the data access requests would return empty.

Cache sync manager 22 may thereby enable an example schemaless data store 38 to be considered a cache-offload data store, or as being integrated with the cache provided by in-memory data grid 21. Cache sync manager 22 may use schemaless data stores 38 to act as an abstract persistent backing store for the cache provided by in-memory data grid 21.

As noted above, cache sync manager 22 may provide bi-directional synchronization between in-memory data grid 21 and schemaless data stores 38. Cache sync manager 22 may synchronize data from a schemaless data store 38 to in-memory data grid 21 as discussed above. Cache sync manager 22 may also synchronize data from in-memory data grid 21 to a schemaless data store 38, and populate a schemaless data store 38 from data already in in-memory data grid 21. Cache sync manager 22 may also store its computed hash code with a key in a schemaless data store 38. If cache sync manager 22 is later restarted (together with in-memory data grid 21, in some examples), cache sync manager 22 may access the hash code from schemaless data store 38 and rapidly re-load its filtering data in filter data structure 27.

The interaction of data access service 20 with enterprise application 25 and schemaless data stores 38 may include insertions of data (or insert queries, or simply “inserts”) from enterprise application 25 to in-memory data grid 21, and retrievals of data (or “gets”). In some examples, such as where in-memory data grid 21 is first activated, cache sync manager 22 may also interact with a schemaless data store 38 by pre-loading data from schemaless data store 38 (or performing a “pre-load”). Insert operations, get operations, and pre-load operations, or inserts, gets, and pre-loads, are further described below.

For an insert, enterprise application 25 may insert key-value data with a key “K” to in-memory data grid 21. Cache sync manager 22 may calculate a hash code for key K and cache the hash code. Cache sync manager 22 may then add the hash code for key K to filter data structure 27, and add the hash code for key K along with the key K and the corresponding value in the key-value pair in schemaless data store 38.

Cache sync manager 22 may handle gets in various ways in relation to a filter data structure 27 of cache sync manager 22. In some examples, filter data structure 27 may be implemented with a probabilistic filter, such as a Bloom filter. In these examples, filter data structure 27 may enable a limited number of possible hash codes, and may overwrite old hash codes for newer keys. In these examples, filter data structure 27 may be enabled to definitively inform cache sync manager 22 that data is absent, in some cases, but may give false positive results, in some cases in which a hash code for sought data exists but refers to a different key with a duplicate hash code. The false positives may be an inherent trade-off for an advantage in processing speed with large (e.g., arbitrarily large) scaling by filter data structure 27 having only a finite number of possible hash codes, by which attempted retrievals to a potentially arbitrarily highly scaled amount of data in schemaless data stores 38 may be filtered. Cache sync manager 22 may thereby contribute to continued fast data access performance for enterprise computing system 14 even as enterprise computing system 14 scales.

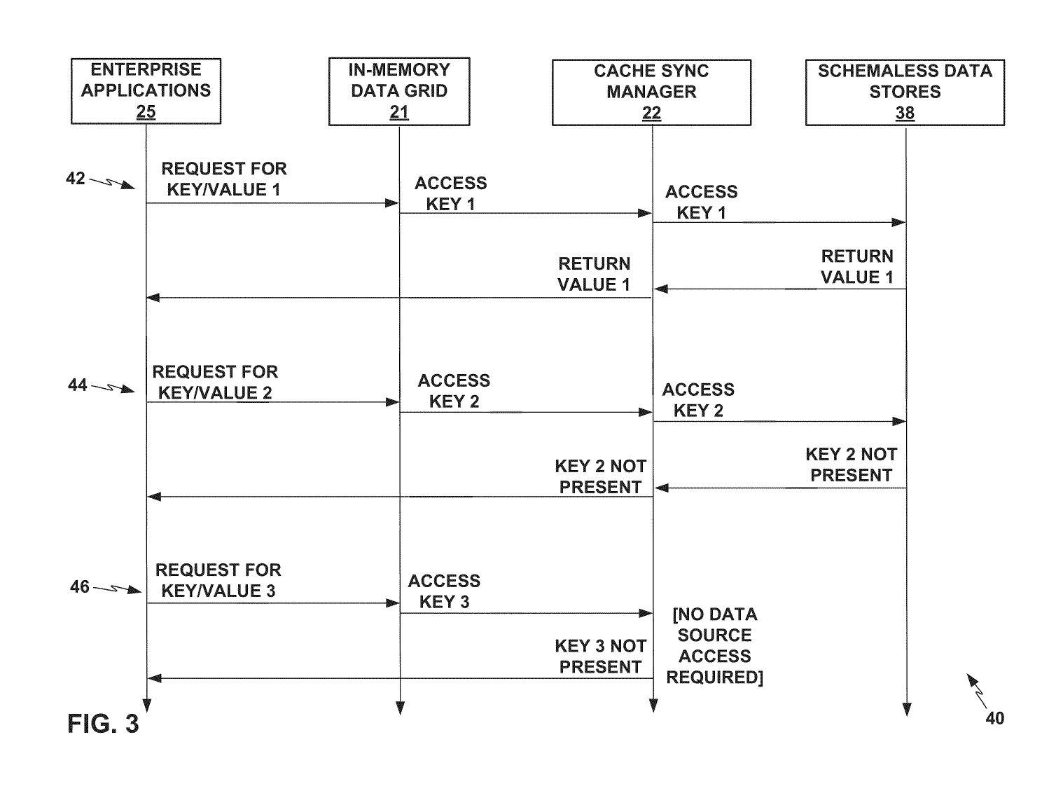

Thus, a probabilistic implementation of filter data structure 27 may respond to an inquiry for whether schemaless data source 38 contains a selected data item with either a definitive no or an ambiguous yes which may be a false positive. In these examples, cache sync manager 22 may find the hash code for K in filter data structure 27 but that hash code may be a duplicate hash code for another key, and schemaless data store 38 may not contain the requested data. In this case, cache sync manager 22 may then perform an attempted retrieval on schemaless data source 38, before informing the enterprise application 25 that the requested data is not available. If cache sync manager 22 determines that filter data structure 27 does not include the hash code of key K, cache sync manager 22 may inform the enterprise application 25 that the requested data is not available, without first having to attempt a data retrieval operation on schemaless data source 38. Examples of this are further described below in reference to FIG. 3.

FIG. 3 depicts a block flow diagram of example data access operation flow 40 for various examples of operations (e.g., get operations) among enterprise applications 25, in-memory data grid 21, cache sync manager 22, and schemaless data stores 38, in accordance with an example of this disclosure. Data access operation flow 40 illustrates the use of cache sync manager 22 to retrieve data from schemaless data stores 38 (e.g., a NoSQL data store) and selectively synchronize the data in in-memory data grid 21 from schemaless data stores 38. Data access operation flow 40 depicts example aspects of enterprise applications 25 accessing in-memory data grid 21, and the role of cache sync manager 22 in ensuring speedier access and data synchronization between in-memory data grid 21 and schemaless data store 38.

For a get, enterprise application 25 may request data for a key-value pair from in-memory data grid 21, as in example get operations 42, 44, 46. For each of the example get operations 42, 44, and 46 in FIG. 3, enterprise application 21 addresses in-memory data grid 21 to retrieve data in the form of a key-value pair, in-memory data grid 21 does not contain the sought data, and cache sync manager 22 takes over the retrieval operation. For each of example get operations 42, 44, and 46, cache sync manager 22 may calculate the hash code for the key for the requested data and check filter data structure 27 for the hash code of the key. In get operation 42, cache sync manager 22 calculates the hash code for key 1, finds that the hash code for key 1 is present in its filter subsystem, requests the corresponding data from schemaless data store 38, receives the corresponding data from schemaless data store 38, and sends the data to enterprise application 25. In this case, cache sync manager 22 may also cache the requested data in in-memory data grid 21 for future cache access.

In get operation 44, cache sync manager 22 may calculate the hash code for key 2, finds that the hash code for key 2 is present in its filter subsystem, requests the corresponding data from schemaless data store 38, and receives back information from schemaless data store 38 that it does not contain the data. In this case, the hash code for key 2 was a duplicate for another key that is present in schemaless data store 38. Cache sync manager 22 may send a message to enterprise application 25 that key 2 is not present in schemaless data store 38.

In get operation 46, cache sync manager 22 calculates the hash code for key 3, and finds that the hash code for key 3 is not present in its filter subsystem. Cache sync manager 22 may send a message to enterprise application 25 that key 3 is not present in schemaless data store 38, without cache sync manager 22 querying schemaless data source 38. Cache sync manager 22 may return this information to enterprise application 25 more quickly than might be possible by querying schemaless data source 38.

In some examples that implement filter data structure 27 with a probabilistic filter, cache sync manager 22 may be implemented to use two or more hash algorithms to hash each key for each data item in schemaless data store 38, and store the two or more resulting key hash codes in filter data structure 27 for each data item. In these examples, the two or more key hash codes may act as redundant references that may substantially reduce the incidence of false positives in checking whether data not present in in-memory data grid 21 may be found in schemaless data sources 38.

For a pre-load, when in-memory data grid 21 is first activated or re-activated, cache sync manager 22 may check through key hash codes pre-loaded in a schemaless data store 38 and populate filter data structure 27 with the hash codes of the keys for all (or some) of the data stored in schemaless data store 38. Cache sync manager 22 may thus avoid loading all of the data from schemaless data store 38 into in-memory data grid 21, but may instead load hash codes for the keys for all (or some) of the data in schemaless data store 38, which may enable potentially faster retrievals of the data from schemaless data store 38. When in-memory data grid 21 is first activated or re-activated, cache sync manager 22 may also check whether schemaless data store 38 includes data for which cache sync tier 22 has not previously calculated and stored key hash codes (such as if new data has been added to schemaless data store 38, or if schemaless data store 38 is being configured for the first time with in-memory data grid 21).

If cache sync manager 22 finds that schemaless data store 38 does contain data without key hash codes, cache sync manager 22 may then calculate and store, in filter data structure 27, hash codes for the keys for all (or some) of the data in schemaless data store 38. In this way as well, cache sync manager 22 may pre-load the key hashes for the data, and rebuild the stored key hashes in filter data structure 27. Cache sync manager 22 may perform this pre-loading and/or rebuilding filter data structure 27 as part of, or rapidly subsequent to, an initial activation or a reactivation of an in-memory data grid 21. In these examples, cache sync manager 22 may provide cache persistence to in-memory data grid 21.

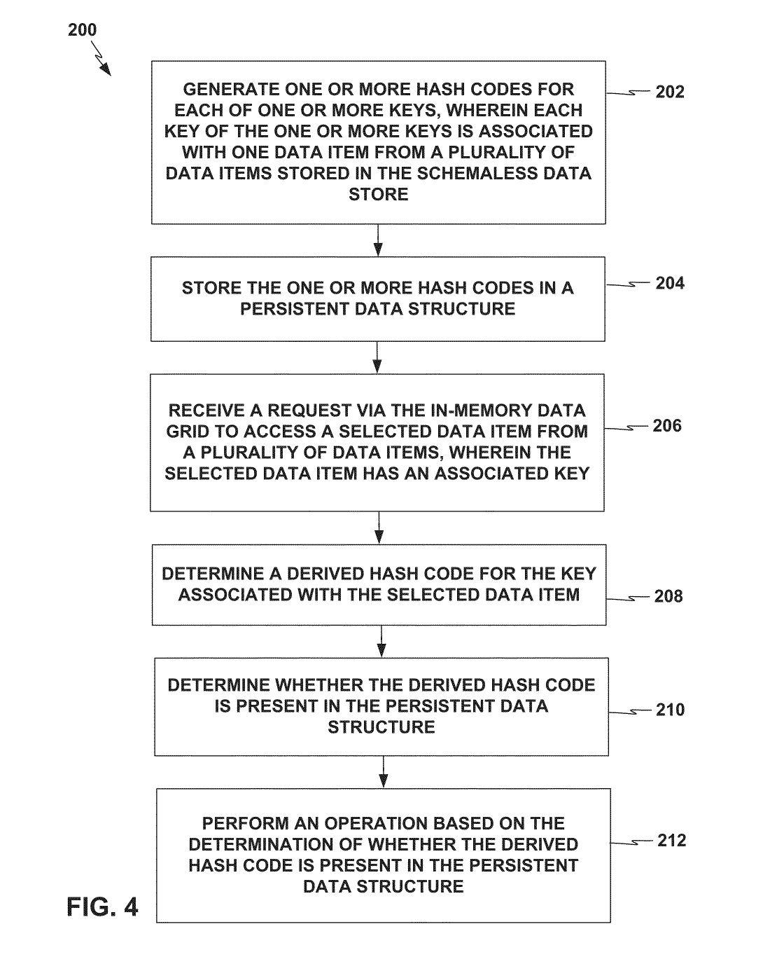

FIG. 4 shows a flowchart for an example overall process 200 that cache sync manager 22, executing on one or more computing devices (e.g., servers, computers, processors), may perform, in accordance with an example of this disclosure. Cache sync manager 22 may generate one or more hash codes for each of one or more keys, wherein each key of the one or more keys is associated with one data item from a plurality of data items stored in the schemaless data store (e.g., schemaless data stores 38) (202). Cache sync manager 22 may store the one or more hash codes in a persistent data structure (e.g., filter data structure 27) (204). Cache sync manager 22 may receive a request via the in-memory data grid (e.g., in-memory data grid 21) to access a selected data item from a plurality of data items, wherein the selected data item has an associated key (206). Cache sync manager 22 may determine a derived hash code for the key associated with the selected data item (e.g., by calculating the hash code from the key based on one or more hashing algorithms) (208). Cache sync manager 22 may determine whether the derived hash code is present in the persistent data structure (210). Cache sync manager 22 may perform an operation based on the determination of whether the derived hash code is present in the persistent data structure (212).

If cache sync manager 22 determines that the derived hash code is not present in the persistent filter data structure, performing the operation based on the determination of whether the derived hash code is present in the persistent filter data structure may include providing a response via the in-memory data grid that the selected data item is not available in the schemaless data store. If cache sync manager 22 determines that the derived hash code is present in the persistent filter data structure, performing the operation based on the determination of whether the derived hash code is present in the persistent filter data structure may include requesting the selected data item from the schemaless data store. Cache sync manager 22 may subsequently receive the selected data item from the schemaless data store, and provide the selected data item via the in-memory data grid. Cache sync manager 22 may also load the selected data item to the in-memory data grid, which may include loading the selected data item into an object in the in-memory data grid. In some examples, performing the operation based on the determination of whether the derived hash code is present in the persistent filter data structure may include receiving information from the schemaless data store that the selected data item is not available, and providing a response via the in-memory data grid that the selected data item is not available in the schemaless data store.

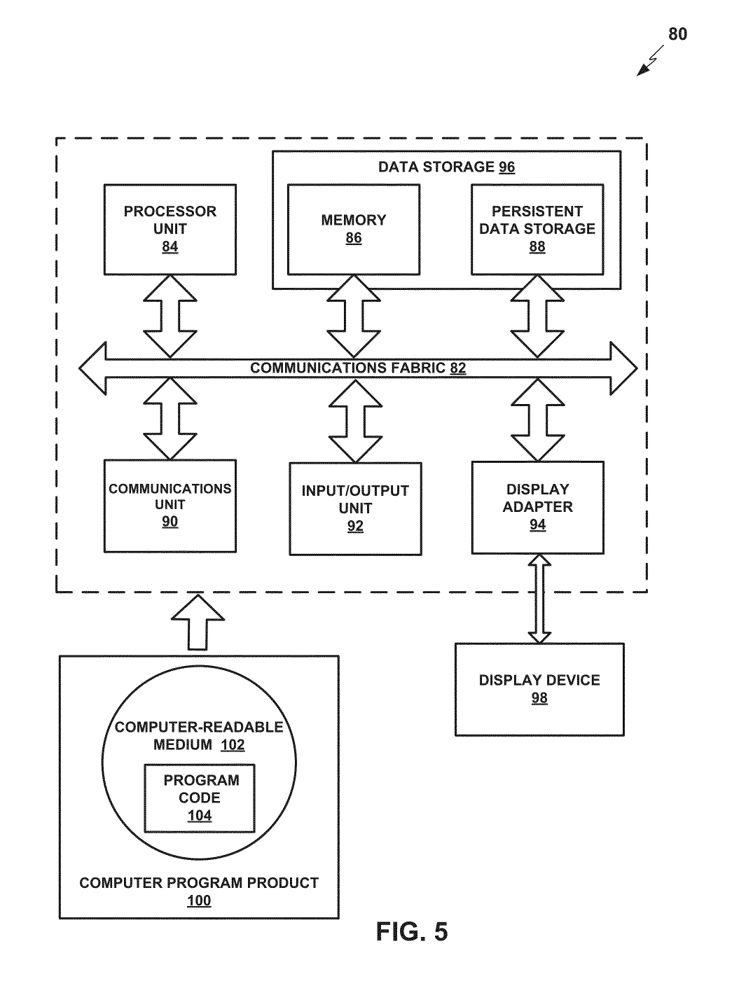

FIG. 5 is a block diagram of a computing device 80 that may be used to execute a cache sync manager 22, in accordance with an example of this disclosure. Computing device 80 may be a server such as one of web servers 14A or application servers 14B as depicted in FIG. 2. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind. Other implementations of a computing device 80 may include a computer having capabilities or formats other than or beyond those described herein.

In the illustrative example of FIG. 5, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a cache sync manager 22, as described in greater detail above. This program code may be stored on memory 86, persistent data storage 88, or elsewhere in computing device 80. This program code may also take the form of program code 104 stored on computer-readable medium 102 (e.g., a computer-readable storage medium) comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of computer-readable medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

As will be appreciated by a person skilled in the art, aspects of the present disclosure may be embodied as a method, a device, a system, or a computer program product, for example. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, a system, apparatus, or device used to store data, but does not include a computer readable signal medium. Such system, apparatus, or device may be of a type that includes, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present disclosure may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present disclosure are described herein with reference to flowchart illustrations and/or block diagrams of methods, apparatus, systems, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1-18. (canceled)

19. A computer program product for managing data between an in-memory data grid and a schemaless data store, the computer program product comprising a computer-readable storage medium having program code embodied therewith, the program code executable by one or more processors to:
generate one or more hash codes for each of one or more keys, wherein each key of the one or more keys is associated with one data item from a plurality of data items stored in the schemaless data store;
store the one or more hash codes in a persistent data structure;
receive a request via the in-memory data grid to access a selected data item from the plurality of data items, wherein the selected data item has an associated key;
determine a derived hash code for the key associated with the selected data item;
determine whether the derived hash code is present in the persistent data structure; and
perform an operation based on the determination of whether the derived hash code is present in the persistent data structure.

20. The computer program product of claim 19,
wherein determining whether the derived hash code is present in the persistent data structure comprises determining that the derived hash code is not present in the persistent data structure, and
wherein performing the operation based on the determination of whether the derived hash code is present in the persistent data structure comprises providing a response via the in-memory data grid that the selected data item is not available in the schemaless data store.

21. The computer program product of claim 19,
wherein determining whether the derived hash code is present in the persistent data structure comprises determining that the derived hash code is present in the persistent data structure,
wherein performing the operation based on the determination of whether the derived hash code is present in the persistent data structure comprises requesting the selected data item from the schemaless data store, and
wherein the program code is further executable by the one or more processors to:
receive the selected data item from the schemaless data store;
load the selected data item into an object in the in-memory data grid; and
provide the selected data item via the in-memory data grid.

22. The computer program product of claim 19, wherein performing the operation based on the determination of whether the derived hash code is present in the persistent data structure further comprises:
receiving information from the schemaless data store indicating that the selected data item is not available in the schemaless data store; and
providing a response via the in-memory data grid that the selected data item is not available in the schemaless data store.

23. A computer system for managing data between an in-memory data grid and a schemaless data store, the computer system comprising:
one or more processors, one or more computer-readable memories, and one or more computer-readable, tangible storage devices;
program instructions, stored on at least one of the one or more storage devices for execution by at least one of the one or more processors via at least one of the one or more memories, to generate one or more hash codes for each of one or more keys, wherein each key of the one or more keys is associated with one data item from a plurality of data items stored in the schemaless data store;
program instructions, stored on at least one of the one or more storage devices for execution by at least one of the one or more processors via at least one of the one or more memories, to store the one or more hash codes in a persistent data structure;
program instructions, stored on at least one of the one or more storage devices for execution by at least one of the one or more processors via at least one of the one or more memories, to receive a request via the in-memory data grid to access a selected data item from the plurality of data items, wherein the selected data item has an associated key;
program instructions, stored on at least one of the one or more storage devices for execution by at least one of the one or more processors via at least one of the one or more memories, to determine a derived hash code for the key associated with the selected data item;
program instructions, stored on at least one of the one or more storage devices for execution by at least one of the one or more processors via at least one of the one or more memories, to determine whether the derived hash code is present in the persistent data structure; and
program instructions, stored on at least one of the one or more storage devices for execution by at least one of the one or more processors via at least one of the one or more memories, to perform an operation based on the determination of whether the derived hash code is present in the persistent data structure.

24. The computer system of claim 23,
wherein determining whether the derived hash code is present in the persistent data structure comprises determining that the derived hash code is not present in the persistent data structure, and
wherein performing the operation based on the determination of whether the derived hash code is present in the persistent data structure comprises providing a response via the in-memory data grid that the selected data item is not available in the schemaless data store.

25. The computer system of claim 23,
wherein determining whether the derived hash code is present in the persistent data structure comprises determining that the derived hash code is present in the persistent data structure,
wherein performing the operation based on the determination of whether the derived hash code is present in the persistent data structure comprises requesting the selected data item from the schemaless data store, and
wherein the computer system further comprises:
program instructions, stored on at least one of the one or more storage devices for execution by at least one of the one or more processors via at least one of the one or more memories, to receive the selected data item from the schemaless data store;
program instructions, stored on at least one of the one or more storage devices for execution by at least one of the one or more processors via at least one of the one or more memories, to load the selected data item into an object in the in-memory data grid; and
program instructions, stored on at least one of the one or more storage devices for execution by at least one of the one or more processors via at least one of the one or more memories, to provide the selected data item via the in-memory data grid.

26. The computer program product of claim 21, wherein loading the selected data item to the in-memory data grid comprises loading the selected data item into an object in the in-memory data grid.

27. The computer program product of claim 19, wherein receiving the request via the in-memory data grid to access the selected data item comprises receiving the request from a client application configured to access the in-memory data grid as a single-address memory.

28. The computer program product of claim 19, wherein the schemaless data store comprises a key-value store, wherein the plurality of data items stored in the schemaless data store comprise a plurality of key-value pairs, and wherein generating the one or more hash codes for each of the one or more keys comprises generating a hash code for a respective key from each of one or more of the key-value pairs.

29. The computer program product of claim 19, wherein the schemaless data store comprises a document store, wherein the plurality of data items stored in the schemaless data store comprise a plurality of documents, and wherein generating the one or more hash codes for each of the one or more keys comprises generating a hash code for a respective key associated with each of one or more of the documents.

30. The computer program product of claim 19, wherein the schemaless data store comprises a column store, wherein the plurality of data items stored in the schemaless data store comprise a plurality of columns, and wherein generating the one or more hash codes for each of the one or more keys comprises generating a hash code for a respective key associated with each of one or more of the columns.

31. The computer program product of claim 19, wherein the schemaless data store comprises a graph data store, wherein the plurality of data items stored in the schemaless data store comprise a plurality of nodes, edges, and properties, and wherein generating the one or more hash codes for each of the one or more keys comprises generating a hash code for a respective key associated with each of one or more of the nodes, edges, or properties.

32. The computer program product of claim 19, wherein the program code is further executable by the one or more processors to:
receive insertions of the plurality of data items with the one or more keys from an application via the in-memory data grid; and
store the plurality of data items in the schemaless data store prior to generating the one or more hash codes for each of the one or more keys.

33. The computer program product of claim 19, wherein the program code is further executable by the one or more processors to:
store the one or more hash codes in the schemaless data store;
activate the in-memory data grid after a period in which the in-memory data grid is not active; and
pre-load the hash codes from the schemaless data store into the persistent data structure.

34. The computer program product of claim 19, wherein the program code is further executable by the one or more processors to:
activate the in-memory data grid after a period in which the in-memory data grid is not active; and
check the schemaless data store for data items for which hash codes are not present in the persistent data structure,
wherein generating the one or more hash codes for each of the one or more keys comprises generating one or more new hash codes for each of one or more keys for data items for which hash codes are not present in the persistent data structure, and
wherein storing the one or more hash codes in the persistent data structure comprises storing the one or more new hash codes in the persistent data structure.

35. The computer program product of claim 19,
wherein generating the one or more hash codes for each of the one or more keys comprises generating two or more hash codes per key for each of the plurality of data items,
wherein determining the derived hash code for the key associated with the selected data item comprises determining two or more derived hash codes for the selected data item, and
wherein determining whether the derived hash code is present in the persistent data structure comprises determining whether the two or more derived hash codes are present in the persistent data structure.

36. The computer program product of claim 19, wherein the persistent data structure comprises a probabilistic filter.

37. The computer program product of claim 19, wherein the persistent data structure comprises a Bloom filter.

38. The computer system of claim 23, further comprising:
program instructions to receive insertions of the plurality of data items with the one or more keys from an application via the in-memory data grid; and
program instructions to store the plurality of data items in the schemaless data store prior to generating the one or more hash codes for each of the one or more keys.
